(19) United States
(12) Patent Application Publication
(10) Pub. No.: US 2011/0219017 A1
(43) Pub. Date: Sep. 8, 2011

(54) SYSTEM AND METHODS FOR CITATION DATABASE CONSTRUCTION AND FOR ALLOWING QUICK UNDERSTANDING OF SCIENTIFIC PAPERS

(76) Inventor: Xu Cui, Fremont, CA (US)

(21) Appl. No.: 12/718,040

(22) Filed: Mar. 5, 2010

(51) Int. Cl. G06F 17/30

(52) U.S. Cl. 707/769; 707/E17.014

(57) ABSTRACT

A computer-implemented method is disclosed for constructing a citation database. The method includes storing initial non-full text information about a citation paper in a citation database, receiving a first request from a first computer device operated by a first user for information about the citation paper in the citation database, sending non-full text information about the citation paper from the citation database to the first computer device, allowing the first user to search on the Internet for a link to a network location storing full-text content of the citation paper, receiving the link to the network location from the first computer device, and storing the link to the network location in the citation database in association with the non-full text information of the citation paper.

### BACKGROUND

The present application relates to database construction for scientific papers and the presentation of the papers.

It is generally recognized that the world economic order is shifting from one based on manufacturing to one based on the generation, organization and use of information. For example, scientific literature continues to be produced at a rapid rate, making it time consuming for researchers to stay current. Most published scientific research appears in paper documents such as scholarly journals or conference proceedings, which include citations to other scientific papers. A researcher could spend large amounts of time for searching, organizing and reading scientific papers, and citing appropriate references at the proper locations in a publication.

A typical researcher needs to read more than a thousand scientific papers each year. While it is relatively easy to find some information of papers such as title, abstract and journal, etc, finding the full-text file and figures of a paper, and how the paper is cited is still time consuming. One drawback associated with the conventional citation data source is that the citation data only stores limited information about the citation papers. The user has to make significant effort to search detailed content such as full-text files and figures from other sources. Another challenge for users of citation tools is that it is rather time consuming to gain a high level understanding what a citation paper is about even when content of the citation paper is available.

Accordingly, there is a continued need for a comprehensive data source for scientific papers. There is also a need to assist users of citation databases to quickly grasp an overview of a citation paper without reading about details of the paper.

### SUMMARY OF THE INVENTION

The present application provides effective ways to construct a citation database that is more comprehensive than convention systems. Text, figures, and other information can be automatically extracted and stored in the citation database in association with citation papers. Users can quickly access full text of a citation paper in the disclosed citation database using a link to the full text of the citation paper stored in the citation database. The disclosed system and methods allow users to quickly understand the meaning of citation papers in the database.

In a general aspect, the present invention relates to a system for accessing citation papers that includes a citation database configured to store a first set of information about a citation paper and a computer processing system. The computer processing system includes a first module that can receive a first request from a first computer device operated by a first user for information about the citation paper stored in the citation database, to send non-full text information about the citation paper from the citation database to the first computer device, to allow the first user to search on the Internet for a network location storing full-text content of the citation paper, and to receive a link to the network location from the first computer device, wherein the citation database can store the link to the network location in association with the first set of information of the citation paper. The computer processing system also includes a second module that can search for a source paper that cites the citation paper and to extract a remark about the citation paper from the source paper. The citation database can store the remark about the citation paper in association with the first set of information about the citation paper.

Implementations of the system may include one or more of the following. The link to the network location can include a web link on the Internet, a uniform resource locator (URL) link, a web address, a network address, an Internet Protocol (IP) address, a HyperText Transfer Protocol (http) address, or a File Transfer Protocol (FTP). The first set of information can include non-full text information about a citation paper. The computer processing system can receive a second request from a second computer device for the citation paper in the citation database, automatically retrieve the link to the network location from the citation database; and send the link to the network location and the non-full text information about the citation paper to the second computer device. The second module can locate the context in the source paper where the citation paper is cited and identify the remark in the context. The computer processing system can receive a second request from a second computer device for the citation paper stored in the citation database and to send the remark about the citation paper by the source paper and the first set of information about the citation paper to the second computer device.

In another general aspect, the present invention relates to a computer-implemented method for constructing a citation database. The method includes storing initial non-full text information about a citation paper in a citation database; receiving a first request from a first computer device operated by a first user for information about the citation paper in the citation database; sending non-full text information about the citation paper from the citation database to the first computer device; allowing the first user to search on the Internet for a link to a network location storing full-text content of the citation paper; receiving the link to the network location from the first computer device; and storing the link to the network location in the citation database in association with the non-full text information of the citation paper.

In another general aspect, the present invention relates to a computer-implemented method for constructing a citation database. The method includes storing a first set of information about a citation paper in a citation database; searching for a source paper that cites the citation paper; extracting, from the source paper, a remark about the citation paper; storing the remark about the citation paper in the citation database in association with the first set of information about the citation paper; receiving a request for information about the citation paper from a computer device; and sending the remark about the citation paper by the source paper and the first set of information about the citation paper to the computer device.

In another general aspect, the present invention relates to a computer-implemented method for constructing a citation database. The method includes storing a first set of information about a citation paper in a citation database; receiving a request from a computer device for information about the citation paper in the citation database; automatically searching on an external database for the citation paper by a computer processing system; identifying at east a portion of the first set of information associated with the citation paper in the external database; finding a second set of information about the citation paper stored in the external database; retrieving the second set of information about the citation paper from the external database; storing the second set of information about the citation paper in the citation database in association with the first set of information about the citation paper; and sending the first set of information and the second set of information about the citation paper to a computer device.

In another general aspect, the present invention relates to a computer-implemented method for constructing a citation database. The method includes storing a first set of information about a citation paper in a citation database; searching for one or more figures in the citation paper; extracting the one or more figures from the citation paper; and storing the one or more figures in the citation database in association with the first set of information about the citation paper.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a system diagram for a citation database in accordance with the present invention.

FIG. 2 is a flowchart for incorporating links to network locations storing full texts of citation papers into a citation database.

FIG. 3 illustrates a data structure for citation papers and network locations storing the full text content of the citation papers.

FIG. 4 is a flowchart for discovering and storing how a citation paper is cited by other papers.

FIG. 5A shows the discovery of remarks made about a citation paper by other papers.

FIG. 5B shows the incorporation of remarks about a citation paper by other papers into a citation database.

FIG. 6 shows data structures to illustrate the automatic incorporation of information about citation papers from an external database into a citation database.

FIG. 7 is a flowchart for automatically incorporating information from an external database into a citation database.

FIG. 8 is a flowchart for automatically extracting figures and thumbnail images from citation papers in a citation database.

FIG. 9A is an exemplified user interface displaying citation papers queried from a citation database and figures of a selected citation paper.

FIG. 9B is another exemplified user interface displaying citation papers queried from a citation database and figures of a selected citation paper when the citation paper is moused-over at the user interface.

FIG. 10A is an exemplified user interface displaying citation papers queried from a citation database and thumbnail images of a selected citation paper.

FIG. 10B is another exemplified user interface showing thumbnail images of a selected citation paper when the citation paper is moused-over at the user interface.

### DETAILED DESCRIPTION OF THE INVENTION

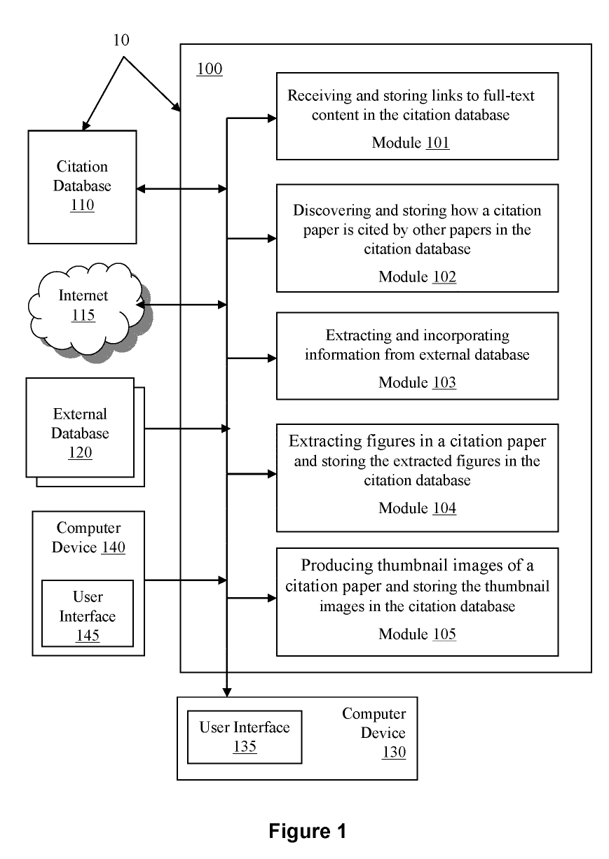

Referring to FIG. 1, a citation system 10 includes a computer processing system 100 and a citation database 110. The computer processing system 100 can also be in communication with one or more external databases 120 and accessible to the Internet 115. The database 110 stores information about a plurality of citation papers, which can include authors' names, the name of the journals where the citation papers are published, the volume and page numbers, date of publications, etc. The computer processing system 100 includes a module 101 configured to receive and store links to full-text content of citation papers in the citation database 110, a module 102 configured to discover how a citation paper is cited by other papers and storing related information in the citation database 110, a module 103 configured to extract and incorporating information from the external database(s) 120, a module 104 configured to extract figures in a citation paper and storing the extracted figures in the citation database 110, and a module 105 configured to produce thumbnail images of a citation paper and store the thumbnail images in the citation database 110.

The computer processing system 100 can be in communication with computer devices 130, 140 operated by different users that may access the citation database 110. The computer devices 130, 140 can receive information about citation papers from the citation database 110 and display the information on user interface 135, 145 respectively. In some embodiments, the computer processing system 100 can be a computer server. The computer devices 130, 140 can be client computers in communication with the remote computer sever. In some embodiments, the computer processing system 100 can be co-located with the computer device 130. For example, the computer processing system 100 can be a computer process chip or program installed in a same computer system as the computer device 130 and the citation database 110 can be locally stored on the computer device 130.

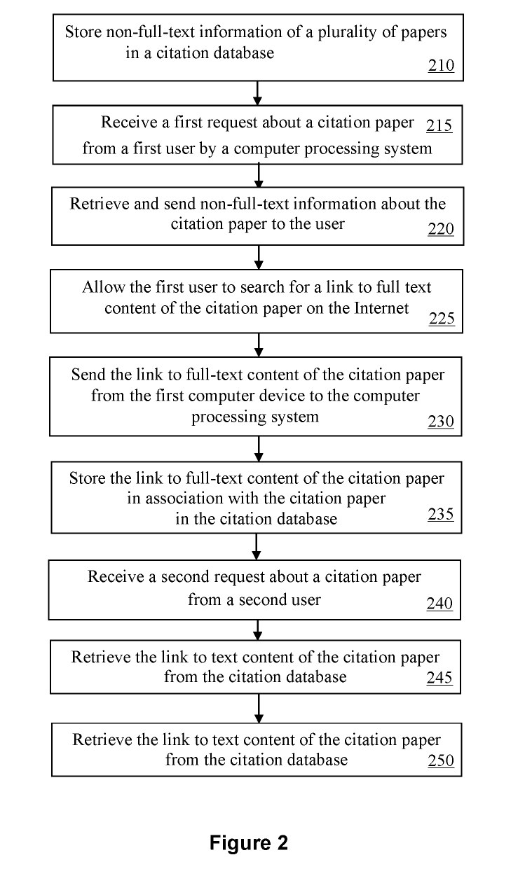

When a user finds partial information of a scientific paper, the user often is interested in reading full text content of the paper. Convention citation databases do not provide full text to the citation papers stored therein. Full texts of scientific papers are usually available, with fee charges, at the papers' respective publishing Journals. The full texts of some scientific papers are also available in publicly accessible websites (for example, at the authors' own web pages). Referring to FIG. 1 and FIG. 2, a plurality of citation papers are stored in the citation database 110. The non-full-text information about the citation papers can include titles, publishing journals, author names, publishing dates etc. (step 210). The computer processing system 100 receives a first request by a first user from a first computer device in communication with the computer storage system (step 215). The first request is for information related to one of the plurality of citation papers in the citation database 110. Since the full text information may not stored in the citation database 110 initially, the computer processing system 100 extracts non-full-text information and sends it to the first computer device 130 operated by the first user (step 220).

In the present application, the term “non-full-text information” refers to information about a citation paper other than the full text of the citation paper. For example, the “non-full-text information” can include paper titles, the names of the publishing journals, author names, publishing dates as well as the abstract of the citation paper.

If the first user is interested in finding full text of the citation paper, the first user can search on the Internet and may find the full text content of the citation paper on the Internet (step 225). The full text of the citation paper may be found, for example, at the publisher' web site, the author' personal webpage, and other websites on the Internet. The full text of the citation paper may also be found in other data sources specialized for scientific publications such as Google Scholar and PubMed. The network location wherein the full text of the citation paper can include a web link on the Internet, a uniform resource locator (URL) link, a web address, a network address, an Internet Protocol (IP) address, a HyperText Transfer Protocol (http) address, or a File Transfer Protocol (FTP). The network location is then sent from the first computer device 130 to the module 101 in the computer processing system 100 (step 230). The module 101 then stores the link to the network location in the citation database 110 in association with the citation paper (step 235). A second request for the same citation paper is separately received from a second computer device 140 by the computer processing system 100 (step 240). The computer processing system 100 retrieves non-full text information about the citation paper and the link to the full-text network location (step 245). The link to the full-text network location is automatically sent, together with other non-full-text information to the second computer device 140 and displayed on the user interface 145 (step 250).

In some embodiments, web locations of full text content of citation papers can be obtained by a web crawler. Web pages containing information about the citation paper are first identified. The text information on a web page is then determined. Section names may be identified to verify full text content on the web page. The link to the web locations the full text content is then stored in association with the citation paper on the citation database 110.

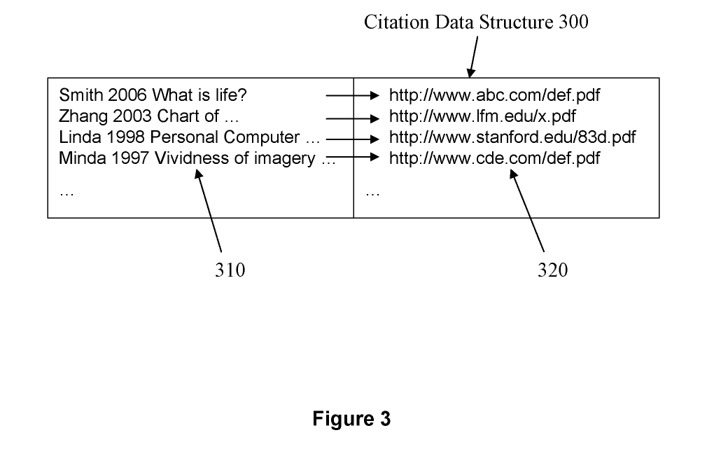

FIG. 3 shows an exemplified data structure 300 that includes non-full text information 310 about citation papers, and the network locations 320 for their full text content, which can be stored in the citation database (110, FIG. 1). The network locations 320 for the full text content of the citation papers can be obtained by users and shared with the computer processing system (100, FIG. 1) and stored in the citation database (110, FIG. 1).

In some embodiments, the citation system 10 can provide ways to discover and store how a citation paper is cited by other papers, which allows a user to quickly grasp the meaning and relevance of a citation paper. The module 102 in the computer processing system 100 in FIG. 1 can parse the content of full-text papers and extract the remarks in the papers about the citation paper. These remarks can serve as cognitive interpretations of other authors gained on the citation paper, and are used in the disclosed systems and methods to assist users' understanding of the citation paper without carefully reading through it.

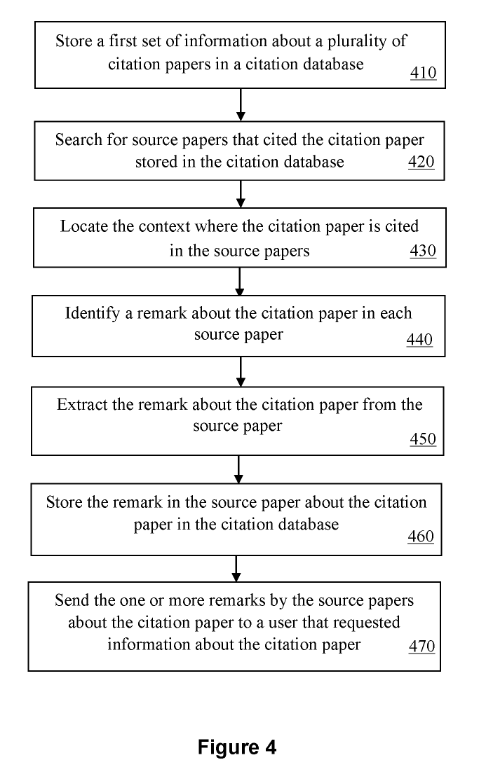

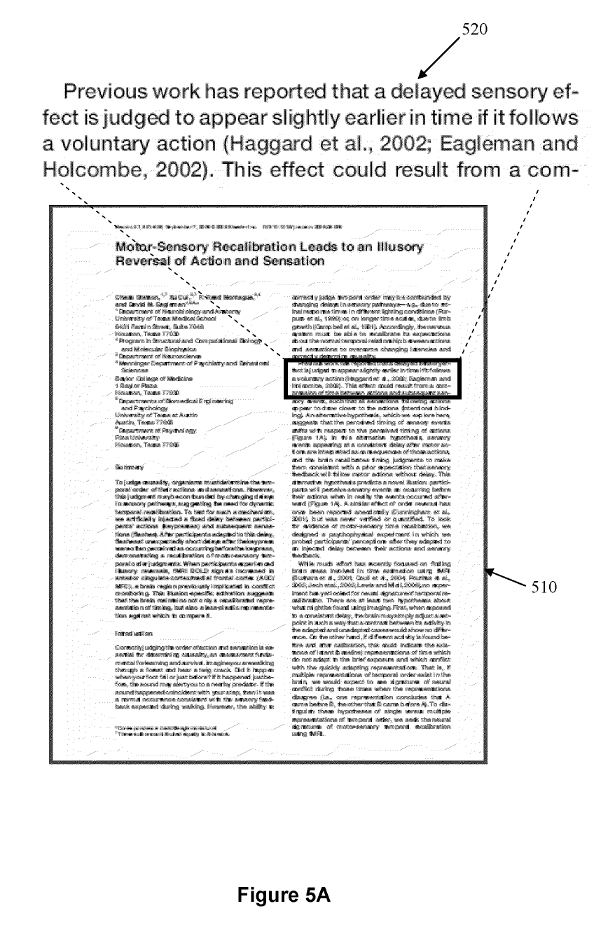

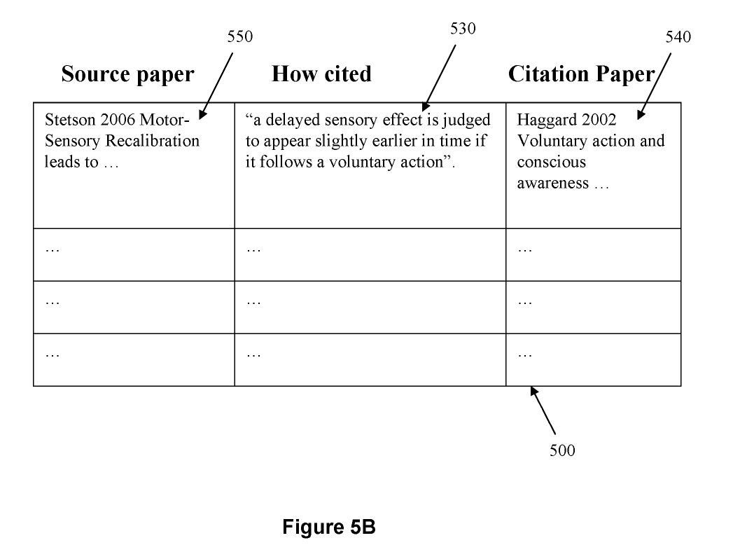

Referring to FIGS. 1, 4, 5A, and 5B, a first set of information about citation papers is stored on a citation database 110 (step 410). The first set of information can include, for example, authors' names, date of publications, and the title of the papers, etc. The module 102 can automatically parse the source papers 510 that cited the citation paper (step 420). Possible sources for source papers that cite the citation paper can include the citation database 110, external database(s) 120 such as Google Scholar and PubMed, the web pages hosted by the group or authors that submitted the source papers. The module 102 locates the context 520 where the citation paper is cited in the source papers (step 430). The module 102 identifies a remark about the citation paper in each source paper that cited the citation paper (step 440). For example, the source paper 510 can cite a paper by Haggard et al., 2002 the context 520 as shown in FIG. 5A. The sentence before the citation location “ . . . a delayed sensory effect is judged to appear slightly earlier in time if it follows a voluntary action” functions as a remark 530 by the source paper about the citation paper (i.e. the Haggard paper). Next, the module 102 extracts the remark 530 about the citation paper from the source paper (step 450). The source papers found by the module 102 are sometimes in plain text, wherein the remark can be relatively easily captured by parsing sentences, phrases and words.

The source papers can be in PDF format, HTML format, or other format. If of PDF format, the text of the source paper can be extracted from the PDF. The citation to the citation paper can be found (step 420), and the context is located (step 430) using the text of the source paper. A remark 530 about the citation paper can then be identified (step 440) and extracted (step 450) in the text of the source paper.

The remark 530 is stored in association with the citation paper 540 with a reference to the source paper 550 in a data structure 500 in the database 110 (step 460). When a user requests information about the citation paper (e.g. Haggard et al, 2002), the computer processing system 100 can retrieve the remark 530, information about the associated source paper 550, and other information about the citation paper from the database 110, and send them to the user (step 470).

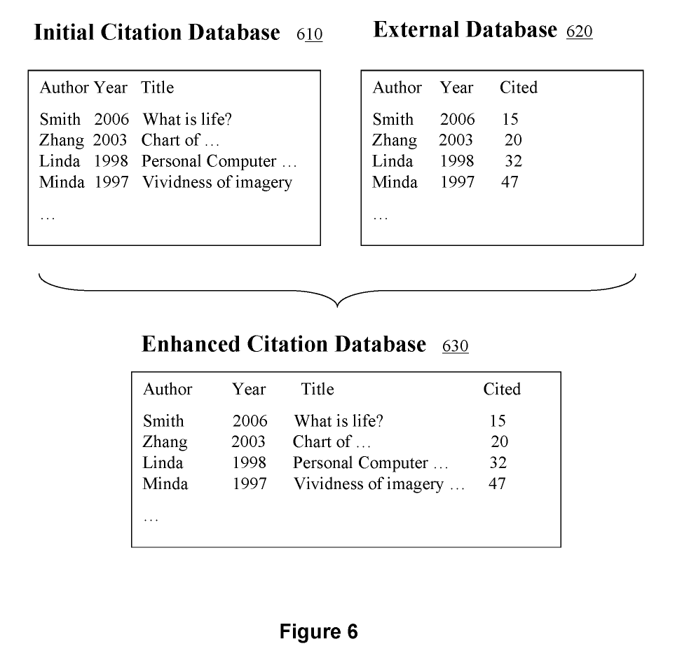

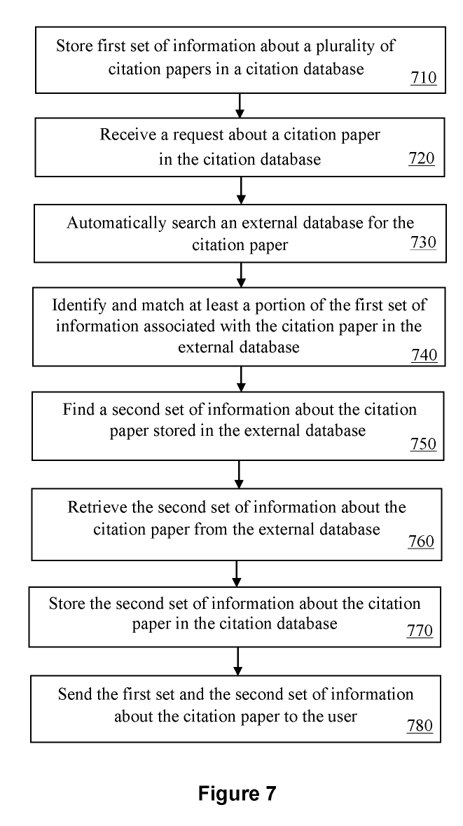

In some embodiments, the citation system 10 can enhance the information stored about citation papers in a citation database by automatically discovering and extracting information from external data sources. Referring to FIGS. 1, 6 and 7, an initial citation database 610 stores a first set of information about citation papers (step 710). The first set of information can include, for example, authors' names, date of publications, and the title of the papers, etc. When a request about a citation paper (e.g. Smith, 2006 “What is life?”) stored on the initial citation database 610 is received from a user by the computer processing system 100 (step 720), the module 103 in the computer processing system 100 extracts the first set of information from the citation database 110. If the module 103 in the computer processing system 100 determines that more information is needed for the citation paper (e.g. the “Smith” paper), it can automatically search one or more external database(s) 620 such as Google Scholar and PubMed (step 730). The module 103 in the computer processing system 100 identifies and matches at least a portion of the first set of information in the external database 620 (step 740). For example, the author's name (e.g. Smith), the date of publication (e.g. 2006), and/or the title of the paper (e.g. “What is life?”) can be found in the external database 620 to unique identify to citation paper as matching the one in the initial citation database 610. The module 103 in the computer processing system 100 then finds a second set of information (e.g. citation count or “Cited”) about the citation paper stored in the external database 620 (step 750). The second set of information (e.g. citation count or “Cited”) about the citation paper is then retrieved from the external database 620 by the module 103 (step 760), which subsequently stored in the citation database 110 (step 770) in association with the first set of information about the citation paper. The first set (e.g. Smith, 2006, “What is life?”) and the second set (e.g. 15 citations) of information about the citation paper is sent to the computer device 130, 140 operated by the user by the computer processing system 100 (step 780).

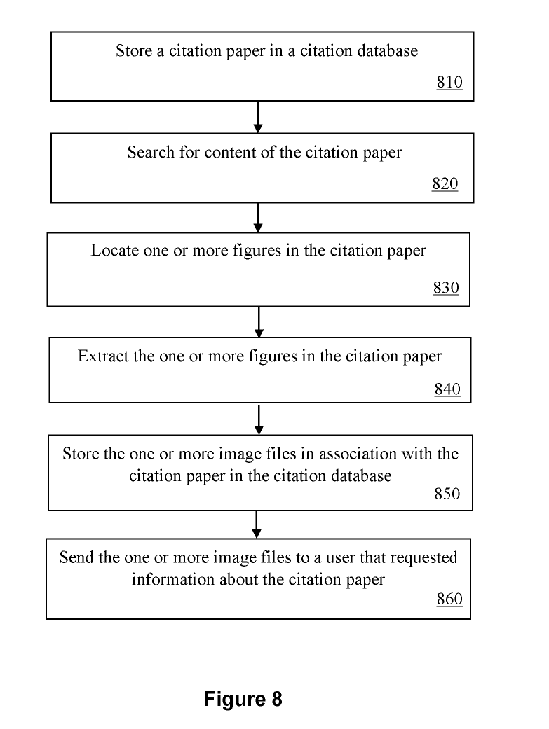

In scientific papers and other informational reports, figures can be the most direct and fastest way to understand a paper. In some embodiments, the citation system 10 can automatically identify and extract figures from citation papers and prominently present the figures to users that request information about the citation paper. Referring to FIGS. 1, 8, 9A, and 9B, the citation database 110 stores a list of citation papers (step 810). The information about the citation papers can include, for example, authors' names, date of publications, the title of the papers, abstract, and other text information. As described above, the modules 102 and 103 can search for content of the citation paper over the Internet 115 and/or the external databases 120 (step 820). The content can include full publication information including full text and figures in the citation paper. Most often, the content is in the form of a pdf file. The module 104 in the computer processing system 100 can locate one or more figures in the citation paper (step 830). The text and figures can be extracted from the citation paper (step 840). The one or more image files are stored by the module 104 in the citation database 110 in association with the citation paper (step 850). When a user requests information about the citation paper, the one or more image files are sent to the computer device 130 operated by the user, and presented on the user interface 135 in association with other information of the citation paper (step 860).

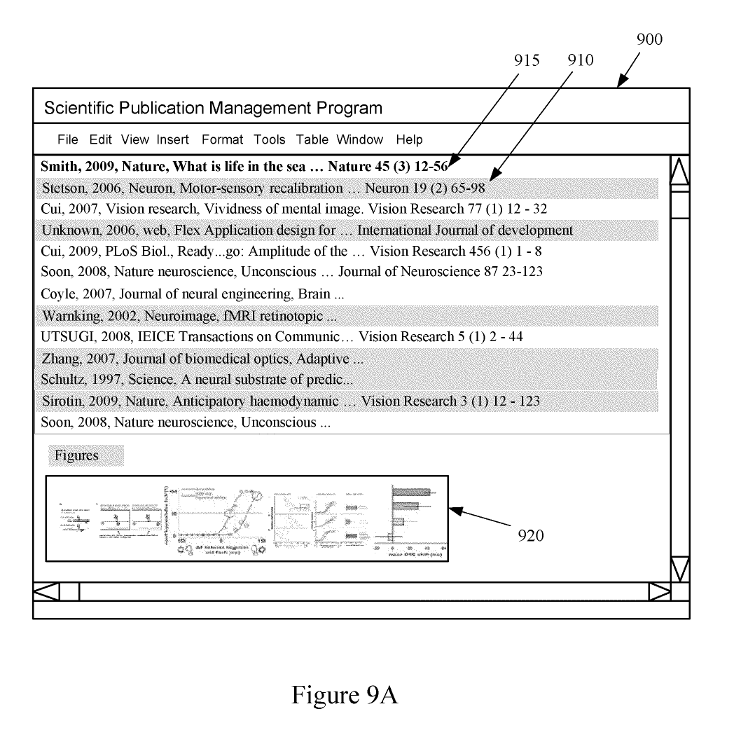

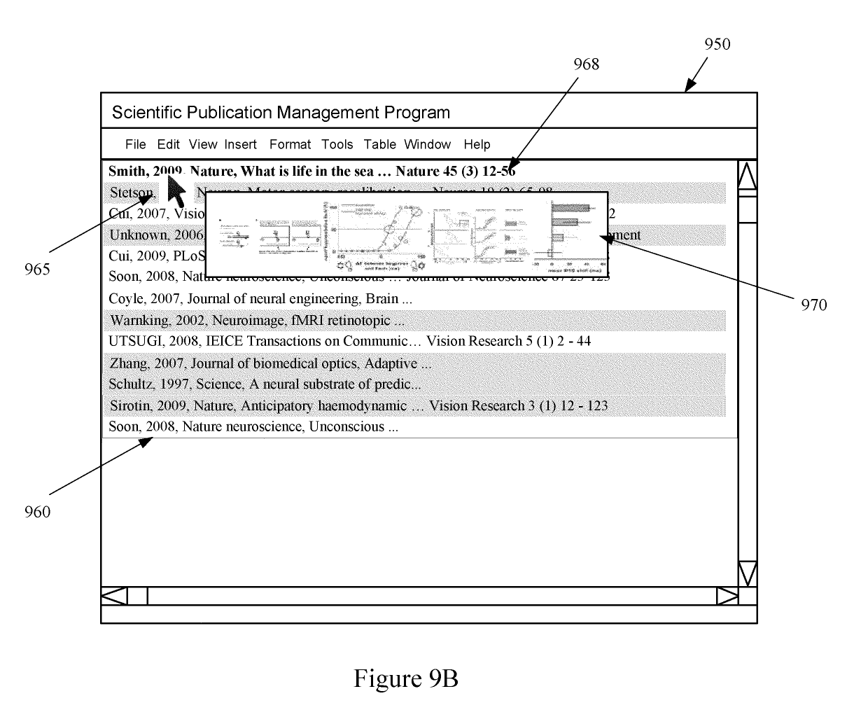

For example, referring to FIG. 9A, a user interface 900 compatible with computer device 130, 140 can display a list of citation papers 910. When a citation paper 915 in the list of citation papers 910 is selected, figures 920 reported in the citation paper 915 are automatically shown. The user can get a quick understanding of the content of the citation paper 915 by looking at the figures without reading full text of the citation paper 915. Similarly, referring to FIG. 9B, another user interface 950 compatible with computer device 130, 140 can display a list of citation papers 960. When the user moves a computer mouse to move a cursor 965 over a citation paper 968, figures 970 reported in the citation paper 968 are automatically displayed next to the citation paper 968.

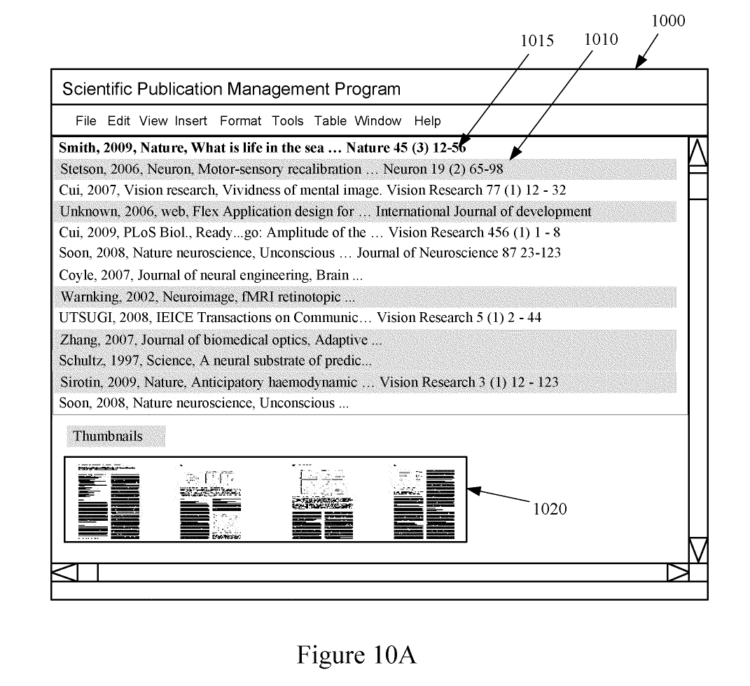

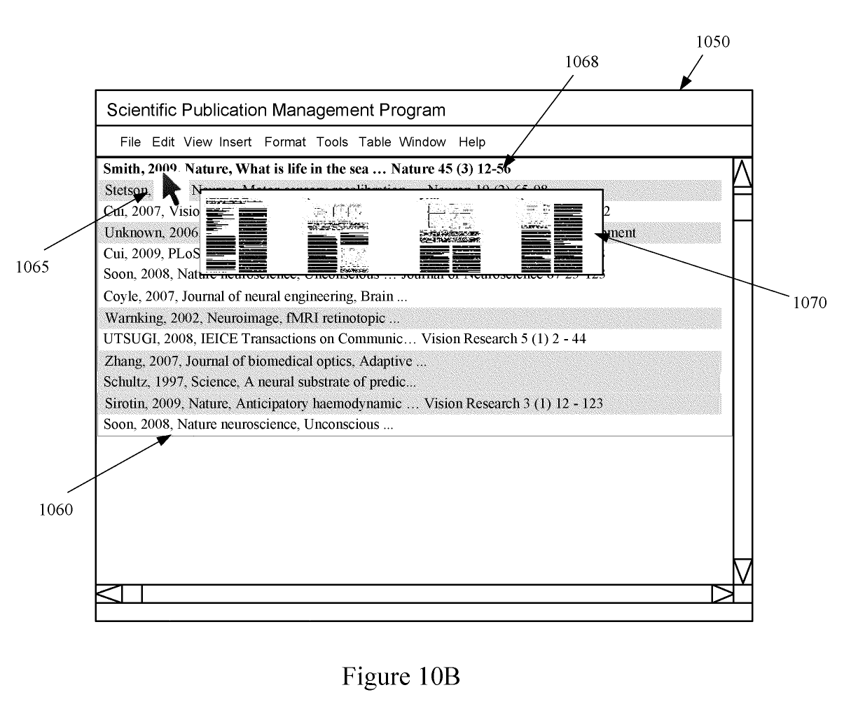

In some embodiments, the citation system 10 can assist a user to navigate a citation paper using thumbnail images. The module 105 in the computer processing system 100 can find full content of citation papers stored in the citation database 110 from the internet 115 or other external or internal sources. The paper content is often stored in pdf files. The pages in full content of the citation paper are automatically converted into thumbnail images by the module 105. The thumbnail images are stored in the citation database 110 in association with their associated citation paper. When a user requests information about the citation paper, the thumbnail images are sent to the computer device 130 operated by the user, and presented on the user interface 135 in association with other information of the citation paper. For example, referring to FIG. 10A, a user interface 1000 compatible with computer device 130, 140 can display a list of citation papers 1010. When a citation paper 1015 in the list of citation papers 1010 is selected, thumbnail images 1020 reported in the citation paper 1015 are automatically shown. A user can achieve a quick understanding of the content of the citation paper 1015 by looking at the thumbnail images. The user can navigate between different pages by clicking on different pages. The thumbnail images can be hyperlinked to corresponding pages on external databases 120 or websites accessible via the Internet 115. Similarly, referring to FIG. 10B, another user interface 1050 compatible with computer device 130, 140 can display a list of citation papers 1060. When a citation paper 1068 in the list of citation papers 1060 is moused over by a cursor 1065, thumbnail images 1070 reported in the citation paper 1068 are automatically displayed next to the citation paper 1068.

It should be understood that the above-described methods are not limited to the specific examples used. Configurations and processes can vary without deviating from the spirit of the invention. For example, the modules in the computer processing system can be configured differently from what is shown in the Figures. Different modules can be combined into a single module. For example, figure extraction and the generation of thumbnail images can be executed in a single module since both operations involve search and access full paper content. Some modules may also be separated into different tasks in different modules. Additionally, the information about citation papers are given above only as examples. The disclosed systems and methods are compatible with other types of information about citation papers. Moreover, the disclosed systems and methods are applicable to informational papers or articles other than scientific papers. For example, the papers can include reports or articles on newspapers, manuals, and book content.

What is claimed is:

1. A system for accessing citation papers, comprising:
a citation database configured to store a first set of information about a citation paper; and
a computer processing system comprising:
a first module configured to:
receive a first request from a first computer device operated by a first user for information about the citation paper stored in the citation database;
send non-full text information about the citation paper from the citation database to the first computer device;
allow the first user to search on the Internet for a network location storing full-text content of the citation paper; and
receive a link to the network location from the first computer device, wherein the citation database is configured to store the link to the network location in association with the first set of information of the citation paper; and
a second module configured to:
search for a source paper that cites the citation paper; and
extract a remark about the citation paper from the source paper, wherein the citation database is configured to store the remark about the citation paper in association with the first set of information about the citation paper.

2. The system of claim 1, wherein the link to the network location comprises a web link on the Internet, a uniform resource locator (URL) link, a web address, a network address, an Internet Protocol (IP) address, a HyperText Transfer Protocol (http) address, or a File Transfer Protocol (FTP).

3. The system of claim 1, wherein the first set of information includes non-full text information about a citation paper.

4. The system of claim 3, wherein the computer processing system is configured to
receive a second request from a second computer device for the citation paper in the citation database;
automatically retrieve the link to the network location from the citation database; and
send the link to the network location and the non-full text information about the citation paper to the second computer device.

5. The system of claim 1, wherein the second module is configured to locate the context in the source paper where the citation paper is cited and identify the remark in the context.

6. The system of claim 1, wherein the computer processing system is configured to
receive a second request from a second computer device for the citation paper stored in the citation database; and
to send, to the second computer device, the remark about the citation paper by the source paper and the first set of information about the citation paper.

7. A computer-implemented method for constructing a citation database, comprising:
storing initial non-full text information about a citation paper in a citation database;
receiving a first request from a first computer device operated by a first user for information about the citation paper in the citation database;
sending non-full text information about the citation paper from the citation database to the first computer device;
allowing the first user to search on the Internet for a link to a network location storing full-text content of the citation paper;
receiving the link to the network location from the first computer device; and
storing the link to the network location in the citation database in association with the non-full text information of the citation paper.

8. The computer-implemented method of claim 7, wherein the link to the network location comprises a web link on the Internet, a uniform resource locator (URL) link, a web address, a network address, an Internet Protocol (IP) address, or a HyperText Transfer Protocol (http) address.

9. The computer-implemented method of claim 7, further comprising:
receiving a second request from a second computer device for the citation paper in the citation database;
automatically retrieving the link to the network location from the citation database; and
sending the link to the network location and non-full text information about the citation paper to the second computer device.

10. A computer-implemented method for constructing a citation database, comprising:
storing a first set of information about a citation paper in a citation database;
searching for a source paper that cites the citation paper;
extracting, from the source paper, a remark about the citation paper;
storing the remark about the citation paper in the citation database in association with the first set of information about the citation paper;
receiving, from a computer device, a request for information about the citation paper; and
sending, to the computer device, the remark about the citation paper by the source paper and the first set of information about the citation paper.

11. The computer-implemented method of claim 10, further comprising:
locating the context in the source paper where the citation paper is cited; and
identifying the remark in the context.

12. The computer-implemented method of claim 10, further comprising:
converting the remark in the sourced paper from an image or a pdf format to a text before the step of extracting, from the source paper, a remark about the citation paper.

13. The computer-implemented method of claim 10, wherein the remark about the citation paper is stored in the citation database in association with information about the source paper and the first set of information about the citation paper.

14. A computer-implemented method for constructing a citation database, comprising:
storing a first set of information about a citation paper in a citation database;
receiving a request from a computer device for information about the citation paper in the citation database;
automatically searching on an external database for the citation paper by a computer processing system;
identifying at east a portion of the first set of information associated with the citation paper in the external database;
finding a second set of information about the citation paper stored in the external database;
retrieving the second set of information about the citation paper from the external database;
storing the second set of information about the citation paper in the citation database in association with the first set of information about the citation paper; and
sending the first set of information and the second set of information about the citation paper to a computer device.

15. The computer-implemented method of claim 14, wherein the first set of information or the second set of information include authors' names, the name of the journals where the citation paper is published, the volume and page numbers, or the date of publication.

16. A computer-implemented method for constructing a citation database, comprising:
storing a first set of information about a citation paper in a citation database;
searching for one or more figures in the citation paper;
extracting the one or more figures from the citation paper; and
storing the one or more figures in the citation database in association with the first set of information about the citation paper.

17. The computer-implemented method of claim 16, further comprising:
receiving, from a computer device, a request for information about the citation paper;
sending, to a computer device, the one or more figures and the first set of information about the citation paper; and
allowing the one or more figures to be displayed in association with the first set of information about the citation paper on the computer device.

18. The computer-implemented method of claim 16, wherein the one or more figures are extracted from the citation paper in pdf format.

19. The computer-implemented method of claim 16, further comprising search for content the citation paper in an external data source, wherein the one or more figures are extracted from the content of the citation paper at the external data source.

20. The computer-implemented method of claim 16, further comprising:
producing the thumbnail images for different pages of the citation paper;
receiving, from a computer device, a request for information about the citation paper;
sending, to a computer device, the thumbnail images and the first set of information about the citation paper; and
allowing the thumbnail images to be displayed in association with the first set of information about the citation paper on the computer device, wherein the thumbnail images are configured to allow a user to navigate among different pages of the citation paper.
